(19) United States
(12) Patent Application Publication
(10) Pub. No.: US 2025/0314903 A1
(43) Pub. Date: Oct. 9, 2025

(54) OPTICAL LAMINATE FOR STEREOSCOPIC IMAGE DISPLAY APPARATUS AND STEREOSCOPIC IMAGE DISPLAY APPARATUS

(71) Applicant: SAMSUNG SDI CO., LTD., Yongin-si (KR)

(72) Inventors: Hye Yeon JWA, Suwon-si (KR); Dae Hee KWAK, Suwon-si (KR); Jun Mo KOO, Suwon-si (KR); Kwang Ho SHIN, Suwon-si (KR)

(21) Appl. No.: 19/098,882

(22) Filed: Apr. 2, 2025

(30) Foreign Application Priority Data
Apr. 3, 2024 (KR) 10-2024-0045102

(51) Int. Cl. G02B 30/25; G02B 5/30

(52) U.S. Cl. CPC G02B 30/25; G02B 5/3025; G02B 5/3083

(57) ABSTRACT

An optical laminate for stereoscopic image display apparatuses and a stereoscopic image display apparatus including the same are disclosed. The optical laminate includes: a negative dispersion retardation layer; and a reflective polarizer and a polarizing plate sequentially formed on at least one surface of the negative dispersion retardation layer. The polarizing plate includes a polarizer and a protective layer formed on at least one surface of the polarizer and satisfies condition (i) or (ii): (i) a protective layer is formed on each of two opposing surfaces of the polarizer, respectively, and each of the protective layers has a thickness of 30 μm or less; and (ii) a protective layer is formed on one surface of the polarizer and the polarizing plate has a thickness of 70 μm or less.

### CROSS-REFERENCE TO RELATED APPLICATION

The present application claims priority to and the benefit of Korean Patent Application No. 10-2024-0045102, filed on Apr. 3, 2024, in the Korean Intellectual Property Office, the entire disclosure of which is incorporated herein by reference.

### BACKGROUND

### 1. Field

The present disclosure relates to an optical laminate for stereoscopic image display apparatuses and a stereoscopic image display apparatus including the same.

### 2. Description of the Related Art

Recently, display apparatuses capable of displaying stereoscopic images, rather than simply displaying images on a flat screen, have been attracting attention.

Conventional stereoscopic image display apparatuses use a pancake lens assembly. However, a stereoscopic image provided by such a display apparatus has limited resolution. Here, resolution refers to contrast ratio, that is, a difference in brightness between light and dark areas on a screen of the display apparatus. The contrast ratio and resolution of the stereoscopic image display apparatus may be adjusted at various locations in the stereoscopic image display apparatus. For example, the pancake lens is located closest to the user's eyes and thus can affect the resolution of the stereoscopic image display apparatus.

The background technique of the present disclosure is disclosed in Korean Patent Laid-open Publication No. 10-2013-0103595 and similar documents.

### SUMMARY

It is an aspect of the present disclosure to provide an optical laminate for stereoscopic image display apparatuses that can reduce or minimize refraction and/or scattering due to abnormal light transmitted from a reflective polarizer as well as reducing or minimizing phase delay of the light.

It is another aspect of the present disclosure to provide an optical laminate for stereoscopic image display apparatuses that can improve the contrast ratio and resolution as well as eliminating light leakage at an edge of a screen within a viewer's field of view.

In accordance with one aspect of the present disclosure, an optical laminate for stereoscopic image display apparatuses is provided.

The optical laminate for stereoscopic image display apparatuses includes: a negative dispersion retardation layer; and a reflective polarizer and a polarizing plate sequentially formed on at least one surface of the negative dispersion retardation layer, wherein the polarizing plate includes a polarizer and satisfies condition (i) or (ii):
(i) a first protective layer is formed on a first surface of the polarizer and a second protective layer is formed on a second surface of the polarizer, the second surface facing away from the first surface, and each of the first and second protective layers is 30 μm or less in thickness; and
(ii) a single protective layer is formed on the first surface or the second surface of the polarizer, and the polarizing plate is 70 μm or less in thickness.

In accordance with another aspect of the present disclosure, a stereoscopic image display apparatus is provided.

The stereoscopic image display apparatus includes the optical laminate for stereoscopic image display apparatuses.

Embodiments of the present disclosure provide an optical laminate for stereoscopic image display apparatuses that can reduce or minimize refraction and/or scattering due to abnormal light transmitted from a reflective polarizer while reducing or minimizing phase delay of the light. Embodiments of the present disclosure provide an optical laminate for stereoscopic image display apparatuses that can improve the contrast ratio and resolution while eliminating light leakage at an edge of a screen within a viewer's field of view.

### BRIEF DESCRIPTION OF THE DRAWINGS

The above and other aspects, features, and enhancements of certain embodiments of the disclosure will be more apparent from the following description taken in conjunction with the accompanying drawings, in which:

FIG. 1 to FIG. 5 are each a conceptual view of an optical laminate according to one or more embodiments.

FIG. 6 is a conceptual view of a stereoscopic image display apparatus according to one or more embodiments.

FIG. 7 is a conceptual view illustrating an angular relationship between an optical axis of a first polarizing plate and a slow axis of a negative dispersion retardation layer of an optical laminate in the stereoscopic image display apparatus, according to one or more embodiments.

FIG. 8 is a conceptual view illustrating an angular relationship between the optical axis of the first polarizing plate and the slow axis of the negative dispersion retardation layer of the optical laminate in the stereoscopic image display apparatus, according to one or more embodiments.

FIG. 9 is a cross-sectional view of a first polarizing plate according to one or more embodiments.

FIG. 10 is a conceptual view of a stereoscopic image display apparatus according to one or more embodiments.

FIG. 11 is a conceptual view illustrating an angular relationship between an optical axis of a first polarizing plate, an optical axis of a second polarizing plate, and a slow axis of a negative dispersion retardation layer of an optical laminate in the stereoscopic image display apparatus, according to one or more embodiments.

FIG. 12 is a conceptual view illustrating an angular relationship between the optical axis of the first polarizing plate, the optical axis of the second polarizing plate, and the slow axis of the negative dispersion retardation layer of the optical laminate in the stereoscopic image display apparatus, according to one or more embodiments.

FIG. 13 is a cross-sectional view of a second polarizing plate according to one or more embodiments.

FIG. 14 is a schematic illustration of an ideal optical path in a pancake lens assembly.

FIG. 15 is a schematic illustration of abnormal light generation in the pancake lens assembly.

### DETAILED DESCRIPTION

Hereinafter, embodiments of the present disclosure will be described with reference to the accompanying drawings. It should be understood that the present disclosure may be embodied in various ways and is not limited to the following embodiments. It should be understood that the following embodiments are provided for complete disclosure and thorough understanding of the disclosure by those skilled in the art. In the drawings, the width or thickness of each element may be exaggerated for descriptive convenience and clarity only. Like components will be denoted by like reference numerals throughout the specification.

The terminology used herein is for the purpose of describing example embodiments and is not intended to limit the present disclosure. As used herein, the singular forms, “a”, “an”, and “the” are intended to include the plural forms as well, unless the context clearly indicates otherwise.

Herein, spatially relative terms such as “upper” and “lower” are defined with reference to the accompanying drawings. Thus, it will be understood that the term “upper surface” can be used interchangeably with the term “lower surface”, and when an element such as a layer or film is referred to as being placed “on” another element, it can be directly placed on the other element, or intervening element(s) may be present. On the other hand, when an element is referred to as being placed “directly on” another element, there are no intervening element(s) therebetween.

Herein, the terms “in-plane retardation Re”, “out-of-plane retardation Rth”, and “degree of biaxiality NZ” are represented by Equations A, B and C, respectively:

$$Re = ( n x - n y ) \times d , \qquad ( A )$$

$$Rth = ( ( n x + ny ) / 2 - nz ) \times d , \qquad ( B )$$

$$NZ = ( nx - nz ) / ( nx - ny ) , \qquad ( C )$$

where nx, ny and nz are the indices of refraction of a corresponding optical element, as measured in the slow axis direction, the fast axis direction, and the thickness direction thereof at a measurement wavelength, respectively, and d is the thickness of the optical element (unit: nm). Here, “slow axis” refers to an axis in which the index of refraction of the optical element in the in-plane direction attains a maximum level and “fast axis” refers to an axis in which the index of refraction of the optical element in the in-plane direction attains a minimum level.

In Equations A to C, the “optical element” may be a retardation layer, a protective layer, or a laminate of retardation layers (e.g., a retardation layer stack). In Equations A to C, the “measurement wavelength” may be 450 nm, 550 nm, or 650 nm.

Herein, the term “short-wavelength dispersion” refers to Re(450)/Re(550) and the term “long-wavelength dispersion” refers to Re(650)/Re(550), wherein Re(450), Re(550), and Re(650) refer to in-plane retardation (Re) of the optical element at wavelengths of about 450 nm, 550 nm, and 650 nm, respectively.

Herein, “cross transmittance (Tc)” is an average of values measured on polarized light passing through polarizers arranged orthogonal to each other at a wavelength of 380 nm to 780 nm.

As used herein, to represent a specific numerical range, the expression “X to Y” means “greater than or equal to X and less than or equal to Y (X≤ and ≤Y)”.

In accordance with one aspect of the present disclosure, an optical laminate may be used in a stereoscopic image display apparatus. The optical laminate may be disposed on an optical path of light emitted from a display unit (described in more detail below) to adjust the light to enable a user to perceive an artificial reality.

The stereoscopic image display apparatus is capable of implementing artificial reality or is associated with an apparatus that implements artificial reality. Artificial reality is a form of reality that has been adjusted in some manner before presentation to a user. For example, artificial reality may include virtual reality (VR), augmented reality (AR), mixed reality (MR), hybrid reality, or a combination thereof. According to one or more embodiments, the stereoscopic image display apparatus may include a pancake lens assembly. The pancake lens assembly is an assembly of multiple optical elements that enables a user to perceive an artificial reality by adjusting an optical path of light emitted from the display unit.

According to one or more embodiments, the optical laminate may be included as at least a part of the pancake lens assembly of the stereoscopic image display apparatus, or may form the pancake lens assembly. That is, the optical laminate may be the pancake lens assembly (i.e., the pancake lens assembly consists of the optical laminate).

The optical laminate can improve the contrast ratio and resolution while eliminating light leakage at an edge of a screen within a viewer's field of view.

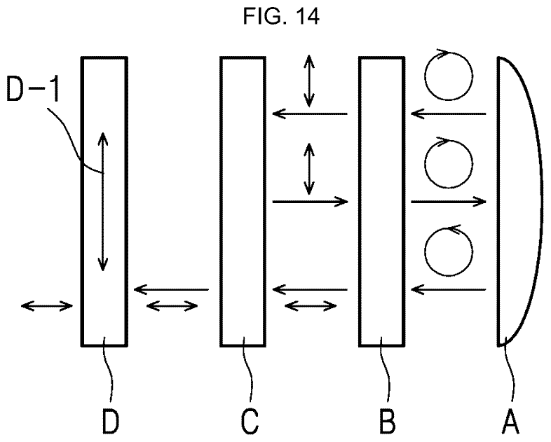

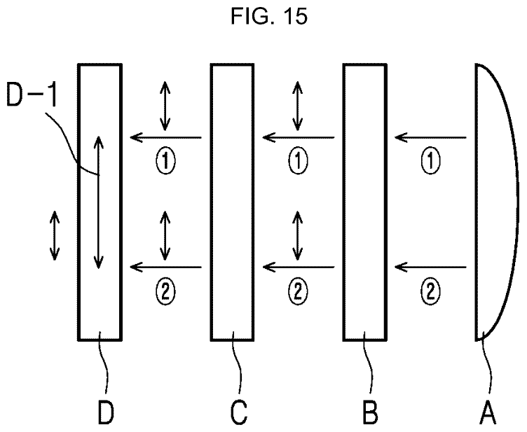

The optical laminate can reduce or minimize refraction and/or scattering due to abnormal light transmitted from a reflective polarizer while reducing or minimizing phase delay of the light. In this regard, the disclosure will be described with reference to FIG. 14 and FIG. 15.

FIG. 14 illustrates an ideal optical path in the pancake lens assembly, and FIG. 15 illustrates a path of abnormal light or stray light in the pancake lens assembly.

In FIG. 14 and FIG. 15, reference numerals A, B, C, D, and D-1 denote a pancake lens, a negative dispersion retardation layer, a reflective polarizer, a polarizing plate, and a light absorption axis of the polarizing plate, respectively.

Referring to FIG. 14, light having sequentially passed through the pancake lens A and the negative dispersion retardation layer B is reflected from the reflective polarizer C to be directed back to the negative dispersion retardation layer B. Here, the reflective polarizer C reflects light vibrating in one direction (light in a vertical direction in FIG. 14, that is, polarized light vibrating in a direction parallel to the light absorption axis D-1 of the polarizing plate D) while completely transmitting light vibrating in a direction perpendicular to the one direction. However, there may be the case where the reflective polarizer C fails to completely reflect light vibrating in the one direction, causing a fraction of the light to be transmitted through the reflective polarizer C as abnormal light or stray light.

Referring to FIG. 15, as indicated by the first path \textcircled{1}, the abnormal light transmitted through the reflective polarizer C may be absorbed by the polarizing plate D. However, as indicated by the second path \textcircled{2}, there may be the case where the abnormal light is visible to a user's eyes as the abnormal light is transmitted through the polarizing plate D due to failure of the polarizing plate D to completely absorb the abnormal light or due to occurrence of phase delay, refraction, and/or interference within the polarizing plate D. In the stereoscopic image display apparatus, visibility of such abnormal light can lead to generation of ghost images and reduction in resolution and contrast ratio.

The inventors of the present disclosure completed the present disclosure based on discovery and confirmation that the degree of visibility of abnormal light or stray light becomes severe with increasing thickness of the polarizing plate or a protective layer of the polarizing plate.

According to one or more embodiments, the optical laminate includes a negative dispersion retardation layer; and a reflective polarizer and a polarizing plate sequentially formed on one surface of the negative dispersion retardation layer. The polarizing plate includes a polarizer and a protective layer formed on at least one surface of the polarizer and satisfies one of condition (i) or (ii):
(i) protective layers are formed on one surface and the other surface (e.g., two opposing surfaces) of the polarizer, respectively, and each of the protective layers has a thickness of 30 μm or less; and
(ii) a protective layer is formed on one surface or the other surface (e.g., one of two opposing surfaces) of the polarizer, and the polarizing plate has a thickness of 70 μm or less.

Now, the optical laminate according to the present disclosure will be described in more detail.

### Negative Dispersion Retardation Layer

The negative dispersion retardation layer serves to linearly polarize circularly polarized light incident from the pancake lens.

The negative dispersion retardation layer may have a short-wavelength dispersion of 0.81 to 0.86. As the negative dispersion retardation layer has a short-wavelength dispersion of 0.81 or more, the negative dispersion retardation layer can eliminate perception of blue ghost images due to leakage of short-wavelength light. As the negative dispersion retardation layer has a short-wavelength dispersion of 0.86 or less, the negative dispersion retardation layer can eliminate perception of blue ghost images due to leakage of short-wavelength light.

According to one or more embodiments, the negative dispersion retardation layer may have a long-wavelength dispersion of 1.01 to 1.04. As the negative dispersion retardation layer has a long-wavelength dispersion of 1.01 or more, the negative dispersion retardation layer can eliminate perception of red ghost images due to leakage of long-wavelength light. As the negative dispersion retardation layer has a long-wavelength dispersion of 1.04 or less, the negative dispersion retardation layer can eliminate perception of red ghost images due to leakage of long-wavelength light.

In one or more embodiments, the negative dispersion retardation layer may have a short-wavelength dispersion of 0.85 to 0.86 and a long-wavelength dispersion of 1.02 to 1.03.

The negative dispersion retardation layer may have an in-plane retardation of 130 nm to 150 nm, for example, 135 nm to 145 nm, at a wavelength of 550 nm. Within these ranges, the negative dispersion retardation layer can easily convert circularly polarized light into linearly polarized light.

The retardation layer may include a non-liquid crystal layer or a liquid crystal layer. The non-liquid crystal layer and the liquid crystal layer may be substantially the same as those used as a first retardation layer and a second retardation layer of a first polarizing plate (described in more detail below).

The negative dispersion retardation layer may have a slow axis and a fast axis in an in-plane direction thereof. The slow axis of the negative dispersion retardation layer may be tilted at an angle of 44° to 46°, for example, 45°, or at an angle of 134° to 136°, for example, 135°, with respect to one side of the negative dispersion retardation layer.

The slow axis of the negative dispersion retardation layer may be tilted at an angle of 44° to 46°, for example, 45°, or at an angle of 134° to 136°, for example, 135°, with respect to a light absorption axis of the polarizer of the polarizing plate (described in more detail below).

The negative dispersion retardation layer may have a thickness of 1 μm to 40 μm, for example, 1.5 μm to 35 μm. Within these ranges, the negative dispersion retardation layer can be suitably used in the optical laminate.

### Reflective Polarizer

The reflective polarizer reflects linearly polarized light vibrating in one direction while transmitting linearly polarized light vibrating in a direction perpendicular to the one direction.

The reflective polarizer may have a light transmittance 85% or more, for example, greater than or equal to 85% and less than 100%, and a haze of 2% or less, as measured in a light transmission direction thereof at a wavelength of 430 nm to 650 nm. Within these ranges, the reflective polarizer can improve luminous efficacy by enhancing transmission of light from the negative dispersion retardation layer therethrough.

The reflective polarizer may have a light transmittance of 1% or less, as measured in a light reflection direction thereof. However, when the light transmittance of the reflective polarizer in the light reflection direction thereof is greater than 0% and less than or equal to 1%, the reflective polarizer can transmit abnormal light or stray light as described above therethrough.

In one or more embodiments, the reflective polarizer may have a structure in which two different layers having different indices of refraction are alternately stacked one above another. For example, the reflective polarizer may be a film in which two different layers having different indices of refraction are stacked in the sequence of higher refractive index layer/lower refractive index layer/higher refractive index layer/lower refractive index layer/ . . .

In one or more embodiments, the reflective polarizer may be a film including a plurality of crystalline domains (for example, polyethylene naphthalate) aligned in one direction within an amorphous matrix (for example, a polycarbonate alloy). For example, the reflective polarizer may be a film including a plurality of polyethylene naphthalate crystalline domains aligned in substantially the same direction within a polycarbonate alloy amorphous matrix.

The thickness of the reflective polarizer may be appropriately selected within the thickness range commonly used for reflective polarizers in the related art. The reflective polarizer may have a thickness of 30 μm or less, for example, greater than 20 μm and less than or equal to 30 μm, or 23 μm to 25 μm. According to one or more embodiments, the optical laminate may include a single layer of the reflective polarizer, or may include two or more layers of the reflective polarizer.

### Polarizing Plate

The polarizing plate may be disposed on an optical path of light transmitted through the reflective polarizer to transmit only linearly polarized light having passed through the reflective polarizer and absorb other light, thereby enabling a user to view stereoscopic images with high contrast and high resolution.

The polarizing plate includes a polarizer and a protective layer formed on at least one surface of the polarizer. The polarizing plate satisfies one of condition (i) or (ii):
(i) protective layers are formed on one surface and the other surface (e.g., two opposing surfaces) of the polarizer, respectively, and each of the protective layers has a thickness of 30 μm or less; and
(ii) a protective layer is formed on one surface or the other surface (e.g., one of the two opposing surfaces) of the polarizer, and the polarizing plate has a thickness of 70 μm or less.

First, condition (i) will be described.

According to condition (i), protective layers are formed on one surface and the other surface of the polarizer, respectively, and each of the protective layers has a thickness of 30 μm or less. That is, a protective layer is formed on each of the two opposing surfaces of the polarizer, and each of the protective layers has a thickness of 30 μm or less.

For convenience, a protective layer formed on one surface of the polarizer, that is, formed between the polarizer and the reflective polarizer, is referred to as a second protective layer, and a protective layer formed on the other surface of the polarizer, that is, formed on a surface of the polarizer opposite to (e.g., facing away from) the reflective polarizer, is referred to as a first protective layer.

For the polarizing plate, each of the first protective layer and the second protective layer has (e.g., is required to have) a thickness of 30 μm or less to reduce or minimize refraction, interference, and/or phase delay of abnormal light or stray light transmitted through the reflective polarizer so as to ensure improved resolution and contrast ratio. If any one of the first protective layer and the second protective layer has a thickness of greater than 30 μm, this can affect an optical path of abnormal light or stray light, resulting in reduction in resolution and contrast ratio.

The first protective layer may have the same thickness as the second protective layer, or may have a different thickness than the second protective layer. For example, the thickness of the first protective layer may be greater than or equal to that of the second protective layer. Because the second protective layer is a layer through which light transmitted from the reflective polarizer passes first, it may be desirable that the thickness of the second protective be smaller than or equal to that of the first protective layer.

For example, the second protective layer may have a thickness of 30 μm or less, for example, greater than 0 μm and less than or equal to 30 μm, or 1 μm to 20 μm. For example, the first protective layer may have a thickness of 30 μm or less, for example, greater than 0 μm and less than or equal to 30 μm, or 5 μm to 30 μm.

According to one or more embodiments, the polarizing plate may have a thickness of 70 μm or less, for example, greater than 0 μm and less than or equal to 70 μm, or 5 μm to 70 μm. Within these ranges, the optical laminate can be more effective at improving resolution and contrast ratio.

The second protective layer may have an in-plane retardation of 5 nm or less, for example, 0 nm to 5 nm, at a wavelength of 550 nm. Within these ranges, the second protective layer can be suitable or advantageous in improving resolution and contrast ratio by reducing or minimizing refraction, interference, and/or phase delay of abnormal light or stray light transmitted from the reflective polarizer with the proviso that the thickness of the second protective layer falls within the ranges described above.

The first protective layer may have an in-plane retardation of 10 nm or less, for example, 0 nm to 10 nm, at a wavelength of 550 nm. Within these ranges, the first protective layer can be suitable or advantageous in improving resolution and contrast ratio by reducing or minimizing refraction, interference, and/or phase delay of abnormal light or stray light transmitted from the reflective polarizer with the proviso that the thickness of the first protective layer falls within the ranges described above.

In some embodiments, the second protective layer has a lower in-plane retardation at a wavelength of 550 nm than the first protective layer.

Each of the first protective layer and the second protective layer may include a protective film or a protective coating layer, which is suitable or advantageous in satisfying the thickness and in-plane retardation requirements described above.

According to one or more embodiments, each of the first protective layer and the second protective layer may include a protective film formed of at least one selected from among cellulose ester resins including triacetylcellulose (TAC) and the like, cyclic polyolefin resins including an amorphous cyclic olefin polymer (COP), polycarbonate resins, polyester resins including polyethylene terephthalate (PET) and the like, polyethersulfone resins, polysulfone resins, polyamide resins, polyimide resins, non-cyclic polyolefin resins, poly(meth)acrylate resins including polymethyl methacrylate and the like, polyvinyl alcohol resins, polyvinyl chloride resins, and polyvinylidene chloride resins, without being limited thereto.

In some embodiments, each of the first protective layer and the second protective layer is a film including a cellulose ester resin.

According to one or more embodiments, each of the first protective layer and the second protective layer may include a protective coating layer formed of an actinic radiation-curable resin composition including an actinic radiation-curable compound and a polymerization initiator. The actinic radiation-curable compound may include at least one selected from among cationic polymerizable curable compounds, radical polymerizable curable compounds, urethane resins, and silicone resins.

At least one of the first protective layer or the second protective layer may further include a functional coating layer. The functional coating layer may be formed on one or both surfaces of the protective layer to provide additional functions to the first protective layer, the second protective layer, and/or the polarizing plate. The functional coating layer may include at least one selected from among a hard coating layer, an anti-fingerprint layer, an antireflection layer, an antiglare layer, a low reflectivity layer, and an ultra-low reflectivity layer, without being limited thereto. According to one or more embodiments, the first protective layer may include a hard coating layer as the functional coating layer.

The polarizer is a light absorbing linear polarizer and has a light absorption axis in an in-plane direction thereof. The light absorption axis of the polarizer may be oriented in substantially the same direction as a machine direction (MD) of the polarizer.

The light absorption axis of the polarizer may be tilted at an angle of 44° to 46°, for example, 45°, or at an angle of 134° to 136°, for example, 135°, with respect to a slow axis of the negative dispersion retardation layer. Within these ranges, the polarizer can be suitable or advantageous in improving resolution and contrast ratio with the proviso that the thicknesses of the first protective layer and the second protective layer fall within the ranges described above.

The polarizer has a light absorption axis in the in-plane direction thereof, wherein the light absorption axis may be substantially orthogonal to a light absorption axis of a polarizer of a first polarizing plate (described in more detail below). Herein, “substantially orthogonal” may include an angle of 90° or an angle in the range of 90°±5°.

The polarizer may have a degree of polarization of 90% or more, for example, 90% to 95%, and a single light transmittance (Ts) of 42% or more, for example, 42% to 45%. Within these ranges of degree of polarization and single light transmittance, the polarizer can make it easy to improve the contrast ratio and resolution with the proviso that the thicknesses of the first protective layer and the second protective layer fall within the ranges described above. Here, the “single light transmittance” refers to a single light transmittance (Ts) measured in the visible spectrum, for example, at a wavelength of 400 nm to 700 nm, and may be measured by a suitable method (e.g., typical method known to those skilled in the art). Here, the “degree of polarization” may be measured by a suitable method (e.g., typical method known to those skilled in the art).

The polarizer may have a cross transmittance of 0.3% or less, for example, 0% to 0.3%, or greater than 0% and less than or equal to 0.2%. Within these ranges, the polarizer can make it easy to improve the contrast ratio and resolution with the proviso that the thicknesses of the first protective layer and the second protective layer fall within the ranges described above.

The polarizer may include a polyvinyl alcohol-based polarizer manufactured by uniaxial stretching of a polyvinyl alcohol film. In one or more embodiments, the polarizer may be manufactured by treating the polyvinyl alcohol film through a series of processes including dyeing, stretching, crosslinking, and color correction. The requirements related to the degree of polarization and light transmittance of the polarizer may be achieved by appropriately adjusting conditions under which the dyeing, stretching, crosslinking, and color correction processes are performed.

The polarizer may have a thickness of 5 μm to 40 μm, for example, 5 μm to 15 μm. Within these ranges, the polarizer can be suitably used in the polarizing plate.

Next, condition (ii) will be described.

According to condition (ii), a protective layer is formed on one surface or the other surface (e.g., one of the two opposing surfaces) of the polarizer, and the polarizing plate has a thickness of 70 μm or less.

For the polarizing plate, the thickness of the polarizing plate is (e.g., required to be) less than or equal to 70 μm to reduce or minimize refraction, interference, and/or phase delay of abnormal light or stray light transmitted from the reflective polarizer so as to ensure improved resolution and contrast ratio. For example, the polarizing plate may have a thickness of greater than 0 μm and less than or equal to 70 μm, for example, 10 μm to 70 μm, or 30 to 70 μm.

The protective layer may be formed only on one surface or the other surface of the polarizer. That is, the protective layer may be formed on only one of the two opposing surfaces and not on both of these surfaces of the polarizer. According to one or more embodiments, the protective layer may be formed on one surface of the polarizer, that is, the surface of the polarizer between the polarizer and the reflective polarizer, or may be formed on the other surface of the polarizer, that is, the surface of the polarizer opposite to (facing away from) the reflective polarizer.

The requirement related to the thickness of the polarizing plate may be achieved by adjusting the thickness of the polarizer and/or the protective layer.

The protective layer may have a thickness of 30 μm or less, for example, greater than 0 μm and less than or equal to 30 μm, 10 μm to 30 μm, or 1 μm to 20 um. Within these ranges, the polarizing plate can easily satisfy the thickness requirement described above.

The protective layer may have an in-plane retardation of 10 nm or less, for example, 0 nm to 5 nm, at a wavelength of 550 nm. Within these ranges, the protective layer can be suitable or advantageous in improving resolution and contrast ratio by reducing phase delay, refraction, and/or scattering of light transmitted from the reflective polarizer with the proviso that the thickness of the protective layer falls within the range described above.

The protective layer may include a protective film or a protective coating layer, which is suitable or advantageous in satisfying the thickness and in-plane retardation requirements described above.

According to one or more embodiments, the protective layer may include a protective film formed of at least one selected from among cellulose ester resins including triacetylcellulose (TAC) and the like, cyclic polyolefin resins including an amorphous cyclic olefin polymer (COP), polycarbonate resins, polyester resins including polyethylene terephthalate (PET) and the like, polyethersulfone resins, polysulfone resins, polyamide resins, polyimide resins, non-cyclic polyolefin resins, poly(meth)acrylate resins including polymethyl methacrylate and the like, polyvinyl alcohol resins, polyvinyl chloride resins, and polyvinylidene chloride resins, without being limited thereto. In some embodiments, the protective layer is a film including a cellulose ester resin.

According to one or more embodiments, the protective layer may include a protective coating layer formed of an actinic radiation-curable resin composition including an actinic radiation-curable compound and a polymerization initiator. The actinic radiation-curable compound may include at least one selected from among cationic polymerizable curable compounds, radical polymerizable curable compounds, urethane resins, and silicone resins.

The protective layer may further include a functional coating layer. The functional coating layer may be formed on one or both surfaces of the protective layer to provide additional functions to the protective layer and/or the polarizing plate. The functional coating layer may include at least one selected from among a hard coating layer, an anti-fingerprint layer, an antireflection layer, an antiglare layer, a low reflectivity layer, and an ultra-low reflectivity layer, without being limited thereto. According to one or more embodiments, the protective layer may include a hard coating layer as the functional coating layer.

The protective layer may be substantially the same as the first protective layer or the second protective layer described in connection with condition (i).

The polarizer is a light absorbing linear polarizer and has a light absorption axis in an in-plane direction thereof. The light absorption axis of the polarizer may be oriented in substantially the same direction as a machine direction (MD) of the polarizer.

The light absorption axis of the polarizer may be tilted at an angle of 44° to 46°, for example, 45°, or at an angle of 134° to 136°, for example, 135°, with respect to the slow axis of the negative dispersion retardation layer. Within these ranges, the polarizer can be suitable or advantageous in improving resolution and contrast ratio with the proviso that the thickness of the polarizing plate falls within the range described above.

The polarizer has a light absorption axis in the in-plane direction thereof, wherein the light absorption axis may be substantially orthogonal to a light absorption axis of a polarizer of a first polarizing plate (described in more detail below). Herein, “substantially orthogonal” may include an angle of 90° or an angle in the range of 90°±5°.

The polarizer may have a degree of polarization of 90% or more, for example, 90% to 95%, and a single light transmittance (Ts) of 42% or more, for example, 42% to 45%. Within these ranges of degree of polarization and single light transmittance, the polarizer can make it easy to improve the contrast ratio and resolution with the proviso that the thickness of the polarizing plate falls within the range described above. Here, the “single light transmittance” refers to a single light transmittance (Ts) measured in the visible spectrum, for example, at a wavelength of 400 nm to 700 nm, and may be measured by a suitable method (e.g., typical method known to those skilled in the art). Here, the “degree of polarization” may be measured by a suitable method (e.g., typical method known to those skilled in the art).

The polarizer may have a cross transmittance of 0.3% or less, for example, 0% to 0.3%, or greater than 0% and less than or equal to 0.2%. Within these ranges, the polarizer can make it easy to improve the contrast ratio and resolution with the proviso that the thickness of the polarizing plated falls within the range described above.

The polarizer may be manufactured by the method described in connection with condition (i).

The polarizer may have a thickness of 5 μm to 40 μm, for example, 5 μm to 15 μm. Within these ranges, the polarizer can be suitably used in the polarizing plate.

The polarizing plate may further include a bonding layer to bond the first protective layer, the second protective layer, or the protective layer to the polarizer. The bonding layer may be formed using a suitable bonding agent (e.g., known to those skilled in the art). For example, the bonding layer may be formed of a water-based bonding agent or a photo-curable bonding agent.

The bonding layer may have a thickness of 100 nm or less, for example, greater than 0 nm and less than or equal to 100 nm, or 50 nm to 70 nm. Within these ranges, the bonding layer can prevent or substantially prevent separation between the polarizer and the protective layer while making it easy to satisfy the thickness requirement of the polarizing plate described above.

The optical laminate may further include a protective member on one surface or the other surface (e.g., one of the two opposing surfaces) of the polarizing plate.

### Protective Member

The protective member may be formed on one surface or the other surface (e.g., one of the two opposing surfaces) of the polarizing plate to protect the polarizing plate. According to one or more embodiments, the protective member may be formed on a surface of the polarizing plate opposite to (e.g., facing away from) the reflective polarizer.

The protective member may be adhesively attached to the polarizing plate through an adhesive layer, a bonding layer, or the like to be integrated with the polarizing plate, or may be spaced apart from the polarizing plate.

The protective member may include a protective film or a protective coating layer.

The protective film and the protective coating layer are substantially the same as those described above.

The protective member may further include a functional coating layer.

The functional coating layer may be formed on one or both sides of the protective film or the protective coating layer to provide additional functions to the protective film or the protective coating layer. The functional coating layer may include at least one selected from among a hard coating layer, an anti-fingerprint layer, an antireflection layer, an antiglare layer, a low reflectivity layer, and an ultra-low reflectivity layer, without being limited thereto.

In one or more embodiments, the functional coating layer may include a low reflectivity layer, an antireflection layer, and/or an antiglare layer. The low reflectivity layer, the antireflection layer, and/or the antiglare layer can aid in reducing or minimizing ghost images by reflecting unwanted light coming from the outside and/or by absorbing light reflected at an interface. The protective member may include at least one of the low reflectivity layer, the antireflection layer, or the antiglare layer.

The optical laminate may further include a pancake lens formed on the other surface of the negative dispersion retardation layer (e.g., the surface facing away from the reflective polarizer).

### Pancake Lens

The pancake lens serves to transmit only a portion of circularly polarized light incident from a first polarizer of a stereoscopic image display apparatus (described in more detail below) while reflecting another portion of the circularly polarized light.

The pancake lens may include a lens base and a half mirror formed on at least one surface of the lens base.

At least one of the two opposing surfaces of the lens base may be curved to facilitate realization of the functions described above. For example, the lens base may include a spherical concave surface, a spherical convex surface, a planar surface, a rotationally symmetrical aspherical surface, or a free-form surface. The lens base may be formed of glass or plastic and may be manufactured by a suitable method (e.g., known in the art with regard to typical pancake lenses).

The half mirror is a translucent mirror that transmits incident light in a ratio of reflectance to transmittance of 50:50, and may include any suitable half mirror used in a stereoscopic image display apparatus.

The optical laminate may further include an adhesive layer to bond the pancake lens, the negative dispersion retardation layer, the reflective polarizer, the polarizing plate, and/or the protective member to each other. The adhesive layer may be formed of a suitable adhesive composition (e.g., known to those skilled in the art). For example, the adhesive layer may include a pressure sensitive adhesive (PSA) layer.

The optical laminate may further include a lens disposed on at least one surface of the negative dispersion retardation layer.

According to one or more embodiments, the optical laminate may further include a first lens disposed between the negative dispersion retardation layer and the pancake lens.

According to one or more embodiments, the optical laminate may further include a second lens disposed on an optical path of light transmitted through the polarizing plate.

### First Lens and Second Lens

Each of the first lens and the second lens may be disposed on an optical path to magnify light emitted from a display unit and having passed through a first polarizing plate or a second polarizing plate (described in more detail below).

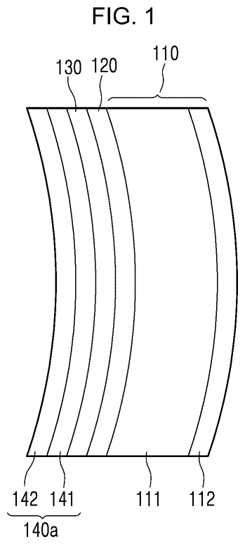

FIG. 1 to FIG. 5 are conceptual views of optical laminates according to various embodiments.

Referring to FIG. 1, an optical laminate may include: a pancake lens 110 including a lens base 111 and a half mirror 112; a negative dispersion retardation layer 120 and a reflective polarizer 130 sequentially formed on the pancake lens 110; and a polarizing plate 140a including a polarizer 141 and a first protective layer 142.

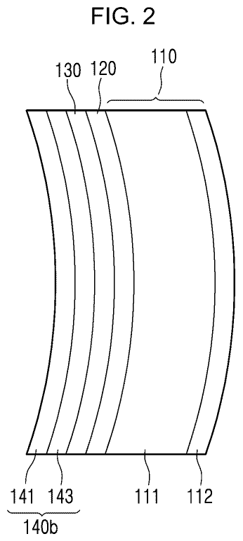

Referring to FIG. 2, an optical laminate may include; a pancake lens 110 including a lens base 111 and a half mirror 112; a negative dispersion retardation layer 120 and a reflective polarizer 130 sequentially formed on the pancake lens 110; and a polarizing plate 140b including a polarizer 141 and a second protective layer 143.

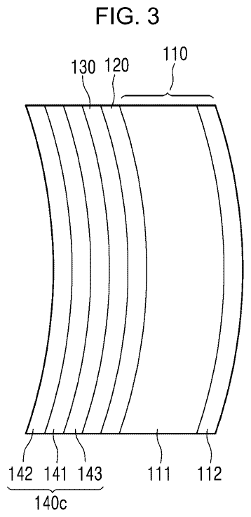

Referring to FIG. 3, an optical laminate may include: a pancake lens 110 including a lens base 111 and a half mirror 112; a negative dispersion retardation layer 120 and a reflective polarizer 130 sequentially formed on the pancake lens 110; and a polarizing plate 140c including a polarizer 141, a first protective layer 142 formed on one surface of the polarizer 141, and a second protective layer 143 formed on the other surface of the polarizer 141.

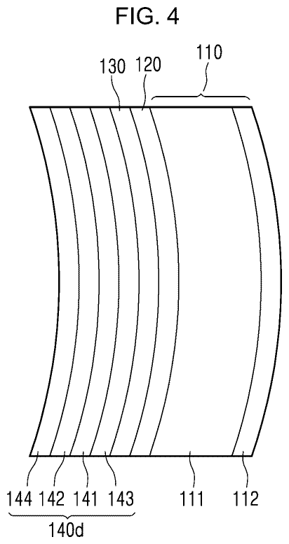

Referring to FIG. 4, an optical laminate may include: a pancake lens 110 including a lens base 111 and a half mirror 112; a negative dispersion retardation layer 120 and a reflective polarizer 130 sequentially formed on the pancake lens 110; and a polarizing plate 140d including a polarizer 141, a first protective layer 142 and a protective member 144 sequentially formed on one surface of the polarizer 141, and a second protective layer 143 formed on the other surface of the polarizer 141.

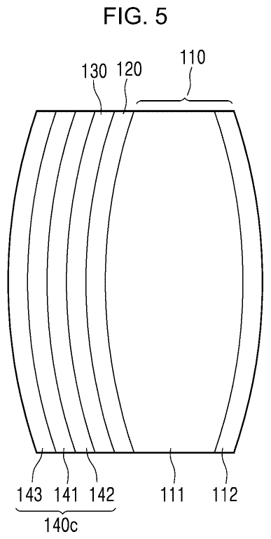

Referring to FIG. 5, an optical laminate may include: a pancake lens 110 including a lens base 111 and a half mirror 112; a negative dispersion retardation layer 120 and a reflective polarizer 130 sequentially formed on the pancake lens 110; and a polarizing plate 140c including a polarizer 141, a first protective layer 142 formed on one surface of the polarizer 141, and a second protective layer 143 formed on the other surface of the polarizer 141.

Although not shown in FIG. 1 to FIG. 5, in one or more embodiments, an adhesive layer may be formed between adjacent layers. Alternatively, the adhesive layer may not be included.

### Stereoscopic Image Display Apparatus

Another aspect of the present disclosure relates to a stereoscopic image display apparatus.

The stereoscopic image display apparatus includes the optical laminate described above.

According to one or more embodiments, the stereoscopic image display apparatus includes a display unit, a first polarizing plate, and a pancake lens assembly. The pancake lens assembly includes the optical laminate described above.

The first polarizing plate and the pancake lens assembly are disposed on an optical path of light emitted from the display unit. The first polarizing plate is disposed between the display unit and the pancake lens assembly.

With the pancake lens assembly, the stereoscopic image display apparatus can have improved contrast ratio and resolution while eliminating light leakage at an edge of a screen within a viewer's field of view.

The stereoscopic image display apparatus according to the present disclosure will be described in detail.

### Display Unit

The display unit may include a suitable display unit that includes a light emitting device. The light emitting device may include at least one of an organic light emitting device, an inorganic light emitting device, or an organic/inorganic hybrid light emitting device.

### First Polarizing Plate

The first polarizing plate may include a linear polarizer and a retardation layer formed on at least one surface of the linear polarizer.

According to one or more embodiments, the first polarizing plate may include a linear polarizer, a first retardation layer formed on one surface of the linear polarizer, and a second retardation layer formed on the other surface of the linear polarizer.

Each of the first retardation layer and the second retardation layer has negative dispersion properties and may have a short-wavelength dispersion of 0.84 to 0.88 and a long-wavelength dispersion of 1.01 to 1.04. Within these ranges, the stereoscopic image display apparatus can produce substantially the same level of light output for each wavelength to allow a user to perceive the same level of light output for each wavelength, can reduce or eliminate light leakage at an edge of a screen within a viewer's field of view, and can enhance resolution. Here, “resolution” refers to contrast ratio, that is, a difference in brightness between light and dark areas on a screen of the stereoscopic image display apparatus. Higher resolution screens produce fewer ghost images.

In one or more embodiments, the first retardation layer may have a short-wavelength dispersion substantially equal to that of the second retardation layer. In addition, the first retardation layer may have a long-wavelength dispersion substantially equal to that of the second retardation layer. This feature can help to provide uniform images by preventing failure due to different degrees of circular polarization for different wavelengths, which can otherwise lead to users perceiving different levels of light output for different wavelengths. Herein, “substantially equal” includes an error range of −0.001 to +0.001, in addition to being exactly equal.

In one or more embodiments, each of the first retardation layer and the second retardation layer may have a short-wavelength dispersion of 0.85 to 0.87 and a long-wavelength dispersion of 1.02 to 1.03.

In one or more embodiments, a slow axis of the first retardation layer may be substantially orthogonal to a slow axis of the second retardation layer. Herein, “substantially orthogonal” refers to an angle in the range of 90°±5°, for example, an angle of 90°. This structure can aid in ensuring that the degree of circular polarization that light emitted from the display unit undergoes while passing through the first retardation layer is substantially the same as the degree of circular polarization that the light having passed through the first retardation layer undergoes while sequentially passing through the polarizer and the second retardation layer, thereby reducing light loss and ensuring substantially the same level of light output for each wavelength.

The slow axis of the second retardation layer is substantially orthogonal to the slow axis of the negative dispersion retardation layer of the pancake lens assembly. Herein, “substantially orthogonal” refers to an angle in the range of 90°±5°, for example, an angle of 90°. This structure can aid in eliminating ghost images and blocking light leakage due to internal scattering.

According to one or more embodiments, the polarizer of the first polarizing plate may have a cross transmittance of 0.3% or less, for example, 0% or less, 0% to 0.1%, or 0.01 to 0.1%. Within these ranges, the polarizer of the first polarizing plate can make it easy to reduce or minimize ghost images by providing an enhanced antireflection effect to the display apparatus satisfying the angular relationship between the slow axes described above. In addition, the aforementioned short-wavelength dispersion and long-wavelength dispersion characteristics of the retardation layers make it easy to enhance the aforementioned effects when a polarizer having a cross transmittance in the above ranges is used in the first polarizing plate.

In one or more embodiments, the first retardation layer may have an in-plane retardation of 115 nm to 125 nm, for example, 119 nm to 123 nm, at a wavelength of 450 nm. The first retardation layer may have an in-plane retardation of 135 nm to 145 nm, for example, 139 nm to 143 nm, at a wavelength of 550 nm. The first retardation layer may have an in-plane retardation of 140 nm to 150 nm, for example, 142 nm to 146 nm, at a wavelength of 650 nm. Within these ranges, the first retardation layer can easily satisfy the short-wavelength dispersion and long-wavelength dispersion requirements described above.

In one or more embodiments, the second retardation layer may have an in-plane retardation of 115 nm to 125 nm, for example, 119 nm to 123 nm, at a wavelength of 450 nm. The second retardation layer may have an in-plane retardation of 135 nm to 145 nm, for example, 139 nm to 143 nm, at a wavelength of 550 nm. The second retardation layer may have an in-plane retardation of 140 nm to 150 nm, for example, 142 nm to 146 nm, at a wavelength of 650 nm. Within these ranges, the second retardation layer can easily satisfy the short-wavelength dispersion and long-wavelength dispersion requirements described above.

According to one or more embodiments, the slow axis of the first retardation layer may be tilted at an angle of substantially 45° with respect to a reference. The slow axis of the second retardation layer may be tilted at an angle of substantially 135° with respect to the reference. At these angles, each of the first retardation layer and the second retardation layer can increase the degree of circular polarization of light emitted from the display unit.

According to one or more embodiments, the slow axis of the first retardation layer may be tilted at an angle of substantially 135° with respect to the reference. The slow axis of the second retardation layer may be tilted at an angle of substantially 45° with respect to the reference. At these angles, each of the first retardation layer and the second retardation layer can increase the degree of circular polarization of light emitted from the display unit.

Herein, the “reference” refers to a light absorption axis of the linear polarizer of the first polarizing plate. The light absorption axis of the polarizer corresponds to a machine direction of the polarizer. Assuming that the display unit has a longer side in a longitudinal direction and a shorter side in a transverse direction, the light absorption axis of the polarizer may be oriented in substantially the same direction as the longitudinal direction of the display unit.

In one or more embodiments, the first retardation layer may have an out-of-plane retardation of 50 nm to 80 nm, for example, 55 nm to 75 nm, at a wavelength of 550 nm. Within these ranges, the first retardation layer can easily satisfy the in-plane retardation requirements described above while aiding in reduction in thickness of the first polarizing plate. In one or more embodiments, the first retardation layer may have a degree of biaxiality of 0.7 to 1.1, for example, 0.8 to 1.0, at a wavelength of 550 nm. Within these ranges, the first retardation layer can easily satisfy the in-plane retardation requirements described above while aiding in reduction in thickness of the first polarizing plate.

In one or more embodiments, the second retardation layer may have an out-of-plane retardation of 50 nm to 80 nm, for example, 55 nm to 75 nm, at a wavelength of 550 nm. Within these ranges, the second retardation layer can easily satisfy the in-plane retardation requirements described above while aiding in reduction in thickness of the first polarizing plate. In one or more embodiments, the second retardation layer may have a degree of biaxiality of 0.7 to 1.1, for example, 0.8 to 1.0, at a wavelength of 550 nm. Within these ranges, the second retardation layer can easily satisfy the in-plane retardation requirements described above while aiding in reduction in thickness of the first polarizing plate.

Each of the first retardation layer and the second retardation layer may have a thickness of 1 μm to 40 μm, for example, 1.5 μm to 35 μm. Within these ranges, the first retardation layer and the second retardation layer can be suitably used in the first polarizing plate.

Each of the first retardation layer and the second retardation layer may be formed of any suitable material that can satisfy the dispersion and retardation requirements described above, without limitation.

Each of the first retardation layer and the second retardation layer may be a liquid crystal layer or a non-liquid crystal layer.

In one or more embodiments, each of the first retardation layer and the second retardation layer may be a liquid crystal layer. For example, the liquid crystal layer may include a cured product of a liquid crystal composition including at least one selected from among a nematic liquid crystal, a smectic liquid crystal, a discotic liquid crystal, and a cholesteric liquid crystal. Each of the first retardation layer and the second retardation layer may further include an alignment film to facilitate alignment of a liquid crystal in the liquid crystal layer. Here, the liquid crystal layer and the alignment layer can be easily prepared by a suitable method (e.g., typical method known to those skilled in the art).

In embodiments in which each of the first retardation layer and the second retardation layer is a liquid crystal layer, the short-wavelength dispersion and long-wavelength dispersion requirements described above may be achieved by adjusting the thickness of the liquid crystal layer, the type of liquid crystal molecules forming the liquid crystal layer, the content of liquid crystal molecules in the liquid crystal layer, and the like.

In embodiments in which each of the first retardation layer and the second retardation layer is a liquid crystal layer, each of the first retardation layer and the second retardation layer may further include an optical film. The optical film facilitates formation of the liquid crystal layer without affecting retardation of the first retardation layer and the second retardation layer.

In one or more embodiments, the optical film may have an in-plane retardation of 10 nm or less, for example, 0 nm to 5 nm, at a wavelength of 550 nm. Within these ranges, there is no influence of the optical film on retardation of the first retardation layer and the second retardation layer.

In one or more embodiments, the optical film may be a film including (e.g., formed of) an optically clear resin. For example, the resin may include at least one selected from among cellulose resins including triacetylcellulose and the like, polyester resins including polyethylene terephthalate (PET), polybutylene terephthalate, polyethylene naphthalate, polybutylene naphthalate, and the like, cyclic olefin copolymer (COC) resins, cyclic olefin polymer (COP) resins, polycarbonate resins, polyether sulfone resins, polysulfone resins, polyamide resins, polyimide resins, polyolefin resins, polyarylate resins, polyvinyl alcohol resins, polyvinyl chloride resins, polyvinylidene chloride resins, and acrylic resins.

In one or more embodiments, each of the first retardation layer and the second retardation layer may be a non-liquid crystal layer.

For example, the non-liquid crystal layer may be a film obtained by uniaxially stretching an unstretched film of an optically clear resin in the MD or transverse direction (TD) thereof or by biaxially stretching the unstretched film in the MD and TD thereof. Here, the optically clear resin is substantially the same as described above.

In embodiments in which each of the first retardation layer and the second retardation layer is a non-liquid crystal layer, the short-wavelength dispersion and long-wavelength dispersion requirements described above may be achieved by adjusting the thickness of the non-liquid crystal layer, the direction of stretching and/or degree of stretching in preparation of the non-liquid crystal layer, the type of resin used in preparation of the non-liquid crystal layer, and the like. For example, the non-liquid crystal layer may be a coating layer prepared by coating a composition including at least one of a cellulose compound or a polystyrene compound as a main component, followed by drying and/or curing.

In embodiments in which each of the first retardation layer and the second retardation layer is a non-liquid crystal layer, each of the first retardation layer and the second retardation layer may further include an optical film. The optical film facilitates formation of the coating layer without affecting retardation of the first retardation layer and the second retardation layer. Because the optical film is substantially the same as described above, detailed description thereof is omitted.

The polarizer may have a degree of polarization of 99% or more, for example, 99.99% to 100%, and a single light transmittance (Ts) of 42% or more, for example, 42% to 45%. Within these ranges of degree of polarization and single light transmittance, the polarizer can have a significantly low reflectance when formed on a retardation film.

The polarizer may include a polyvinyl alcohol-based polarizer obtained by uniaxial stretching of a polyvinyl alcohol film. In one or more embodiments, the polarizer may be manufactured by treating the polyvinyl alcohol film through a series of processes including dyeing, stretching, crosslinking, and color correction. The requirements related to the degree of polarization and light transmittance of the polarizer may be achieved by appropriately adjusting conditions under which the dyeing, stretching, crosslinking, and color correction processes are performed.

The polarizer may have a thickness of 5 μm to 40 μm. Within this range, the polarizer can be suitably used in the polarizing plate.

A resin layer may be further formed on a surface of the polarizer facing the pancake lens assembly.

In one or more embodiments, the resin layer may be directly formed on and bonded to the surface of the polarizer facing the pancake lens assembly. Herein, “directly formed” means that no other layers, such as adhesive layer, bonding layer, and/or curable coating layer, are formed between the polarizer and the resin layer. The resin layer provides enhanced removal of ghost images by covering fine irregularities on the surface of the polarizer. The resin layer may be a cured product of a composition including at least one of a heat-curable resin or a UV-curable resin. Each of the heat-curable resin and the UV-curable resin may be selected from among suitable heat-curable resins or UV-curable resins (e.g., known to those skilled in the art). For example, the resin layer may include a cured product of a composition including a (meth)acrylic resin.

In one or more embodiments, a laminate of the resin layer and an optical film may be formed on the surface of the polarizer facing the pancake lens assembly. The optical film enhances mechanical strength of the first polarizer, and the resin layer provides enhanced removal of ghost images by covering fine irregularities on the surface of the optical film. The resin layer and the optical film may be substantially the same as described above.

In one or more embodiments, the resin layer may include a hard coating layer, but the present disclosure is not limited thereto.

In one or more embodiments, the optical film and the resin layer may be sequentially formed on the surface of the polarizer facing the pancake lens assembly.

The first polarizing plate may further include a protective layer, a functional coating layer, and/or a protective layer with a functional coating layer formed thereon, at an outermost side thereof facing the pancake lens assembly.

The protective layer protects the polarizer and enhances the reliability and mechanical strength of the first polarizing plate. The protective layer may be omitted if desired mechanical properties of the first polarizing plate can be secured without the protective layer.

In one or more embodiments, the protective layer may be formed on a surface of the second retardation layer facing the pancake lens assembly.

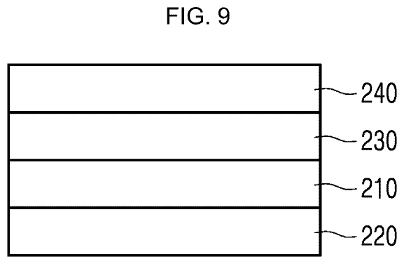

FIG. 9 is a cross-sectional view of a first polarizing plate according to one or more embodiments.

Referring to FIG. 9, the first polarizing plate may include: a first polarizer 210; a first retardation layer 220 bonded to a surface of the first polarizer 210 facing the display unit (not shown); and a second retardation layer 230 and a protective layer 240 sequentially bonded to a surface of the first polarizer 210 facing the pancake lens assembly (not shown), and the protective layer 240 has a functional coating layer formed thereon.

Although not shown in FIG. 9, in one or more embodiments, a bonding layer or an adhesive layer (for example, a pressure sensitive adhesive (PSA) layer) may be disposed to bond the first retardation layer, the second retardation layer, and the protective layer to the first polarizer.

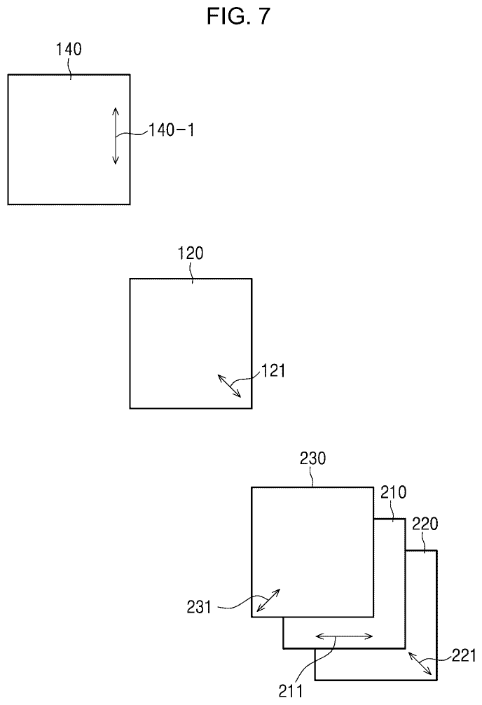

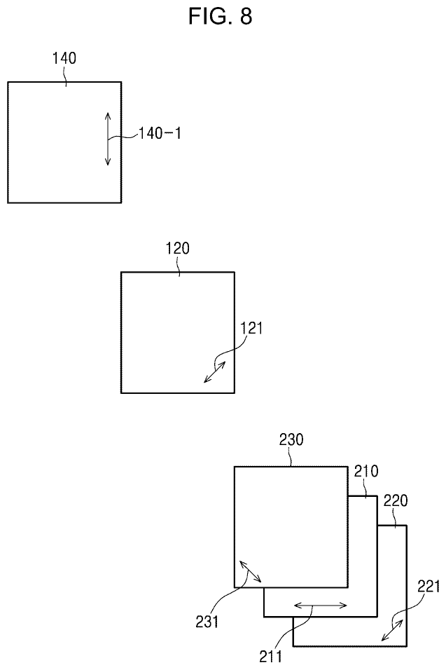

FIG. 7 and FIG. 8 are views illustrating an axial relationship between the first polarizing plate and the retardation film of the pancake lens assembly according to various embodiments.

Referring to FIG. 7, in the first polarizing plate, a light absorption axis 211 of the first polarizer 210 may be tilted at an angle of substantially 45° with respect to a slow axis 221 of the first retardation layer 220 and tilted at an angle of substantially 135° with respect to a slow axis 231 of the second retardation layer 230, and the slow axis 221 of the first retardation layer 220 may be substantially orthogonal to the slow axis 231 of the second retardation layer 230.

Referring to FIG. 8, in the first polarizing plate, the light absorption axis 211 of the first polarizer 210 may be tilted at an angle of substantially 135° with respect to the slow axis 221 of the first retardation layer 220 and tilted at an angle of substantially 45° with respect to the slow axis 231 of the second retardation layer 230, and the slow axis 221 of the first retardation layer 220 may be substantially orthogonal to the slow axis 231 of the second retardation layer 230.

In one or more embodiments, the first polarizing plate may have a light transmittance of 3% or less, for example, 0% to 3%, at a wavelength of 380 nm. Within these ranges, the first polarizing plate can prevent or substantially prevent damage to the light emitting device of the display unit due to UV light coming in from the outside. A method of realizing light transmittance in the above range is known to those skilled in the art. For example, a light absorber capable of absorbing light at a wavelength of 380 nm may be incorporated into one of the components of the first polarizing plate.

### Pancake Lens Assembly

The pancake lens assembly includes the optical laminate described above.

Referring to FIG. 7 and FIG. 8, the slow axis 231 of the second retardation layer 230 may be substantially orthogonal to the slow axis 121 of the negative dispersion retardation layer 120 of the pancake lens assembly, and the light absorption axis 140-1 of the polarizing plate 140 may be tilted at an angle of 45° with respect to the slow axis 121 of the negative dispersion retardation layer 120.

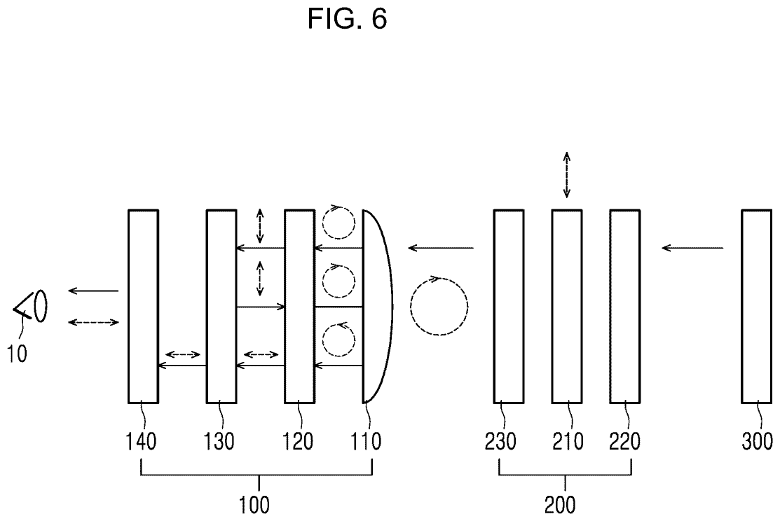

FIG. 6 is a conceptual view of a stereoscopic image display apparatus according to one or more embodiments.

Referring to FIG. 6, a stereoscopic image display apparatus includes: a display unit 300; a first polarizing plate 200 including a first retardation layer 220, a first polarizer 210, and a second retardation layer 230; and a pancake lens assembly 100 including a pancake lens 110, a negative dispersion retardation layer 120, a reflective polarizer 130, and a polarizing plate 140. Light finally emitted through the pancake lens assembly 100 is perceived by a user's eyes 10.

Next, a stereoscopic image display apparatus according to another embodiment will be described.

The stereoscopic imaging display apparatus according to this embodiment may further include a second polarizing plate between the first polarizing plate and the pancake lens assembly.

The second polarizing plate includes a second polarizer, a third retardation layer, and a fourth retardation layer, as will be described in more detail below.

The second polarizing plate serves to enhance luminous efficacy by transmitting circularly polarized light from the first polarizing plate without changing the polarization state thereof or by causing light other than circularly polarized light from the first polarizing plate to be circularly polarized before exiting the second polarizing plate.

The second polarizing plate includes: a second polarizer; a third retardation layer bonded to a surface of the second polarizer facing the display unit; and a fourth retardation layer bonded to a surface of the second polarizer facing the pancake lens assembly.

In one or more embodiments, each of the third retardation layer and the fourth retardation layer may have negative dispersion properties.

In one or more embodiments, each of the third retardation layer and the fourth retardation layer has a short-wavelength dispersion of 0.84 to 0.88 and a long-wavelength dispersion of 1.01 to 1.04. Within these ranges, the third retardation layer and the fourth retardation layer can enhance luminance of an optical display apparatus through increase in internal transmittance.

In one or more embodiments, the third retardation layer may have an in-plane retardation of 115 nm to 125 nm, for example, 119 nm to 123 nm, at a wavelength of 450 nm. The third retardation layer may have an in-plane retardation of 135 nm to 145 nm, for example, 139 nm to 143 nm, at a wavelength of 550 nm. The third retardation layer may have an in-plane retardation of 140 nm to 150 nm, for example, 142 nm to 146 nm, at a wavelength of 650 nm. Within these ranges, the third retardation layer can easily satisfy the short-wavelength dispersion and long-wavelength dispersion requirements described above.

In one or more embodiments, the fourth retardation layer may have an in-plane retardation of 115 nm to 125 nm, for example, 119 nm to 123 nm, at a wavelength of 450 nm. The fourth retardation layer may have an in-plane retardation of 135 nm to 145 nm, for example, 139 nm to 143 nm, at a wavelength of 550 nm. The fourth retardation layer may have an in-plane retardation of 140 nm to 150 nm, for example, 142 nm to 146 nm, at a wavelength of 650 nm. Within these ranges, the fourth retardation layer can easily satisfy the short-wavelength dispersion and long-wavelength dispersion requirements described above.

In one or more embodiments, the third retardation layer may have a short-wavelength dispersion and long-wavelength dispersion substantially equal to those of the fourth retardation layer. This feature can help to provide uniform images by preventing failure due to different degrees of circular polarization for different wavelengths, which can otherwise lead to users perceiving different levels of light output for different wavelengths. Herein, “substantially equal” includes an error range of −0.001 to +0.001, in addition to being completely equal.

Each of the third retardation layer and the fourth retardation layer has a slow axis in an in-plane direction thereof, wherein the slow axis of the third retardation layer is substantially orthogonal to the slow axis of the fourth retardation layer.

In one or more embodiments, the slow axis of the third retardation layer may be tilted at an angle of substantially 45° with respect to a reference. The slow axis of the fourth retardation layer may be tilted at an angle of substantially 135° with respect to the reference. At these angles, each of the third retardation layer and the fourth retardation layer can increase the degree of circular polarization of light emitted from the display unit for each wavelength.

In another embodiment, the slow axis of the third retardation layer may be tilted at an angle of substantially 135° with respect to the reference. The slow axis of the fourth retardation layer may be tilted at an angle of substantially 45° with respect to the reference. At these angles, each of the third retardation layer and the fourth retardation layer can increase the degree of circular polarization of light emitted from the display unit for each wavelength.

Herein, the “reference” refers to the light absorption axis of the first polarizer of the first polarizing plate. The light absorption axis of the first polarizer corresponds to a machine direction of the first polarizer. Assuming that the display unit has a longer side in a longitudinal direction and a shorter side in a transverse direction, the light absorption axis of the first polarizer may be oriented in substantially the same direction as the longitudinal direction of the display unit.

In one or more embodiments, the third retardation layer may have an out-of-plane retardation of 50 nm to 80 nm, for example, 55 nm to 75 nm, at a wavelength of 550 nm. Within these ranges, the third retardation layer can easily satisfy the in-plane retardation requirements described above while aiding in reduction in thickness of the second polarizing plate.

In one or more embodiments, the third retardation layer may have a degree of biaxiality of 0.7 to 1.1, for example, 0.8 to 1.0, at a wavelength of 550 nm. Within these ranges, the third retardation layer can easily satisfy the in-plane retardation requirements described above while aiding in reduction in thickness of the second polarizing plate.

In one or more embodiments, the fourth retardation layer may have an out-of-plane retardation of 50 nm to 80 nm, for example, 55 nm to 75 nm, at a wavelength of 550 nm. Within these ranges, the fourth retardation layer can easily satisfy the in-plane retardation requirements described above while aiding in reduction in thickness of the second polarizing plate.

In one or more embodiments, the fourth retardation layer may have a degree of biaxiality of 0.7 to 1.1, for example, 0.8 to 1.0, at a wavelength of 550 nm. Within these ranges, the fourth retardation layer can easily satisfy the in-plane retardation requirements described above while aiding in reduction in thickness of the second polarizing plate.

Each of the third retardation layer and the fourth retardation layer may have a thickness of 1 μm to 40 μm, for example, 1.5 μm to 35 μm. Within these ranges, each of the third retardation layer and the fourth retardation layer can be suitably used in the second polarizing plate.

Each of the third retardation layer and the fourth retardation layer may be formed of any suitable material that can satisfy the dispersion and retardation requirements described above, without limitation. Each of the third retardation layer and the fourth retardation layer may be a liquid crystal layer or a non-liquid crystal layer.

Because the liquid crystal layer and the non-liquid crystal layer are substantially the same as those described above with regard to the first polarizing plate, detailed description thereof will be omitted. It will be understood that each of the third retardation layer and the fourth retardation layer may further include an optical film as described above.

Each of the third retardation layer and the fourth retardation layer may further include an optical film. The optical film may facilitate formation of a coating layer as described above without affecting retardation of the third retardation layer and the fourth retardation layer. Because the optical film is substantially the same as that described above, detailed description thereof will be omitted.

The second polarizer may have a light absorption axis in an in-plane direction thereof, wherein the light absorption axis may be substantially parallel to the light absorption axis of the first polarizer of the first polarizing plate. Herein, “substantially parallel” means an angle of 0° or an angle of 0°±5°.

The second polarizer may have a cross transmittance of 0.1% or less, for example, 0% to 0.1%, or 0.01% to 0.1%. Within these ranges, the second polarizer can aid in reducing or minimizing ghost images by providing an enhanced antireflection effect the display apparatus satisfying the angular relationship between the slow axes described above.

The second polarizer may have a degree of polarization of 99% or more, for example, 99.99% to 100%, and a single light transmittance (Ts) of 42% or more, for example, 42% to 45%. Within these ranges of degree of polarization and single light transmittance, the second polarizer can have a significantly low reflectance when formed on the retardation layer stack.

The second polarizer may have a thickness of 5 μm to 40 μm. Within this range, the second polarizer can be suitably used in the polarizing plate.

A resin layer may be further formed on a surface of the second polarizer facing the pancake lens assembly.

In one or more embodiments, the resin layer may be directly formed on and bonded to the surface of the second polarizer facing the pancake lens assembly.

Herein, “directly formed” means that no other layers, such as adhesive layer, bonding layer, and/or curable coating layer, are formed between the second polarizer and the resin layer. The resin layer may provide enhanced removal of ghost images by covering fine irregularities on the surface of the second polarizer. The resin layer may be a cured product of a composition including at least one of a heat-curable resin or a UV-curable resin. Each of the heat-curable resin and the UV-curable resin may be selected from among suitable heat-curable resins or UV-curable resins (e.g., known to those skilled in the art). For example, the resin layer may include a cured product of a composition including a (meth) acrylic resin.

In one or more embodiments, a laminate of the resin layer and an optical film may be formed on the surface of the second polarizer facing the pancake lens assembly. The optical film enhances mechanical strength of the second polarizer, and the resin layer provides enhanced removal of ghost images by covering fine irregularities on the surface of the optical film. The resin layer and the optical film may be substantially the same as those described above.

In one or more embodiments, the resin layer may include a hard coating layer, but the present disclosure is not limited thereto.

The second polarizing plate may further include a protective layer, a functional coating layer, and/or a protective layer with a functional coating layer formed thereon, at outermost side thereof facing the pancake lens assembly.

The protective layer serves to protect the second polarizer and enhance the reliability and mechanical strength of the second polarizing plate. The protective layer may be omitted if desired mechanical properties of the second polarizing plate can be secured without the protective layer.

In one or more embodiments, the protective layer may be formed on a surface of the fourth retardation layer facing the pancake lens assembly.

The protective layer is substantially the same as the protective layer described above with regard to the first polarizing plate.

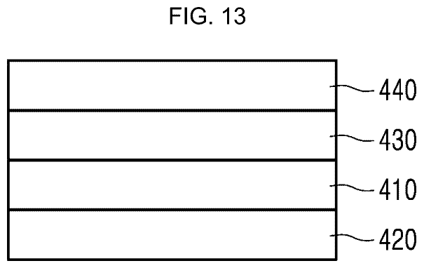

FIG. 13 is a cross-sectional view of a second polarizing plate according to one or more embodiments.

Referring to FIG. 13, the second polarizing plate may include: a second polarizer 410; a third retardation layer 420 bonded to a surface of the second polarizer 410 facing the display unit (not shown); and a fourth retardation layer 430 and a protective layer 440 sequentially bonded to a surface of the second polarizer 410 facing the pancake lens assembly (not shown), and the protective layer 440 has a functional coating layer formed thereon. Although not shown in FIG. 13, in one or more embodiments, the second polarizing plate may further include a bonding layer or an adhesive layer (for example, a pressure sensitive adhesive (PSA) layer) to bond the third retardation layer, the fourth retardation layer, and the protective layer to the second polarizer.

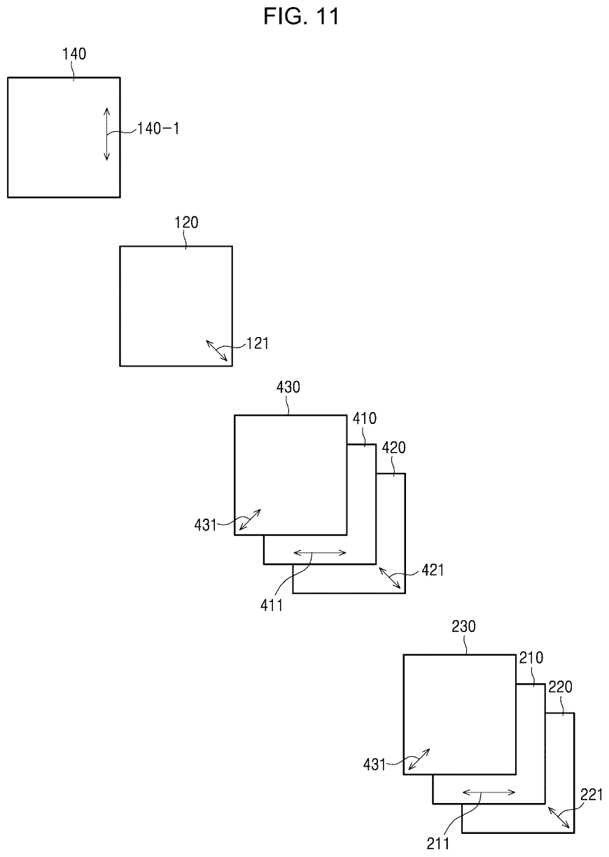

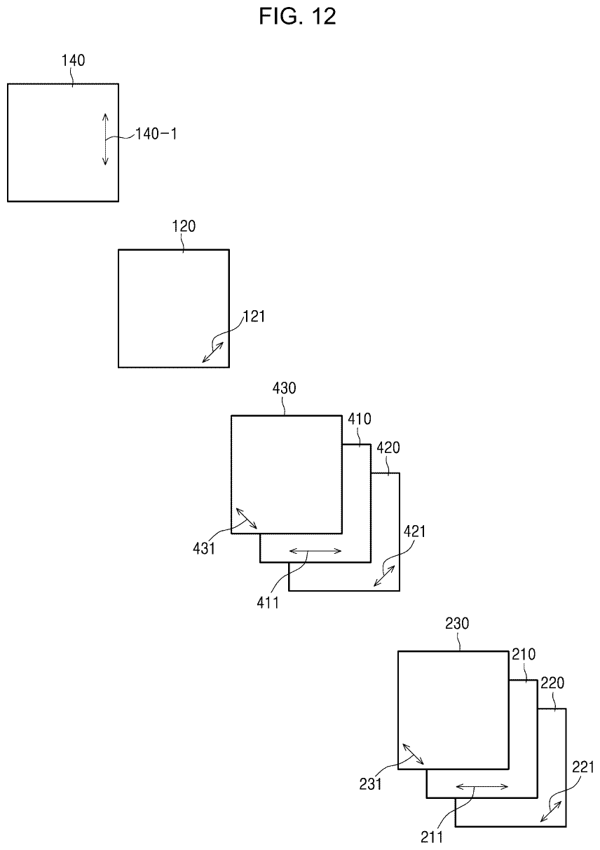

FIG. 11 and FIG. 12 illustrate an axial relationship between the first polarizing plate and the retardation layer of the pancake lens assembly according to various embodiments.

Referring to FIG. 11, the light absorption axis 211 of the first polarizer 210 may be tilted at an angle of substantially 45° with respect to the slow axis 221 of the first retardation film (also referred to as a first retardation layer interchangeably) 220 and tilted at an angle of substantially 135° with respect to the slow axis 231 of the second retardation film (also referred to as a second retardation layer interchangeably) 230; the slow axis 221 of the first retardation film 220 may be substantially orthogonal to the slow axis 231 of the second retardation film 230; a light absorption axis 411 of the second polarizer 410 may be tilted at an angle of substantially 45° with respect to a slow axis 421 of the third retardation film 420 and tilted at an angle of substantially 135° with respect to the slow axis 431 of the fourth retardation film 430; and the slow axis 421 of the third retardation film 420 may be substantially orthogonal to the slow axis 431 of the fourth retardation film 430.

Referring to FIG. 12, the light absorption axis 211 of the first polarizer 210 may be tilted at an angle of substantially 135° with respect to the slow axis 221 of the first retardation film 220 and tilted at an angle of substantially 45° with respect to the slow axis 231 of the second retardation film 230; the slow axis 221 of the first retardation film 220 may be substantially orthogonal to the slow axis 231 of the second retardation film 230; the light absorption axis 411 of the second polarizer 410 may be tilted at an angle of substantially 135° with respect to the slow axis 421 of the third retardation film 420 and tilted at an angle of substantially 45° with respect to the slow axis 431 of the fourth retardation layer 430; and the slow axis 421 of the third retardation film 420 may be substantially orthogonal to the slow axis 431 of the fourth retardation film 430.

In one or more embodiments, the second polarizing plate may have a light transmittance of 3% or less, for example, 0% to 3%, at a wavelength of 380 nm. Within these ranges, the second polarizing plate can prevent or substantially prevent damage to the light emitting device of the display unit due to UV light coming in from the outside. A method of realizing light transmittance in the above range is known to those skilled in the art. For example, a light absorber capable of absorbing light at a wavelength of 380 nm may be incorporated into one of the components of the second polarizing plate.

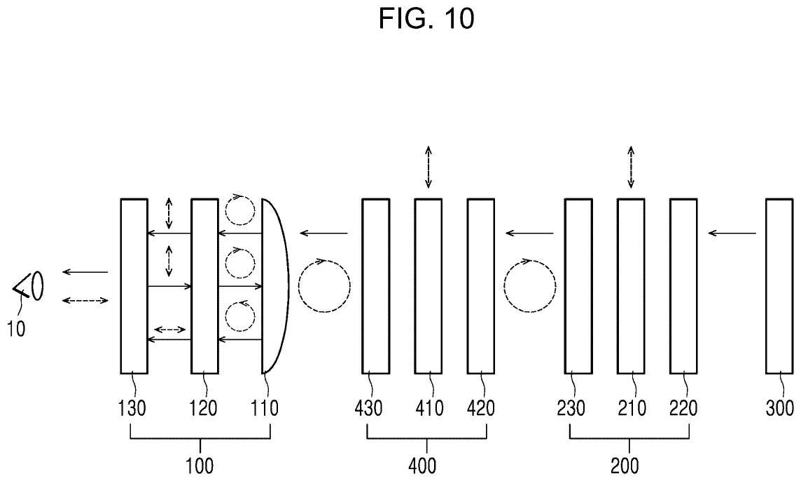

FIG. 10 is a conceptual view of a stereoscopic image display apparatus according to one or more embodiments.

Referring to FIG. 10, in the stereoscopic image display apparatus according to this embodiment, a second polarizing plate 400 including a second polarizer 410, a third retardation layer 420, and a fourth retardation layer 430 may be further disposed between the pancake lens assembly 100 and the first polarizing plate 200, different from the stereoscopic image display apparatus of FIG. 6.

Although not shown in FIG. 10, in some embodiments, the stereoscopic image display apparatus may further include a lens between the second polarizing plate 400 and the first polarizing plate 200. The lens serves to produce an enlarged image by magnifying circularly polarized light from the first polarizing plate 200. Both surfaces of the lens may be curved to facilitate realization of the functions described above. For example, the lens may include a spherical concave surface, a spherical convex surface, a planar surface, a rotationally symmetrical aspherical surface, or a free-form surface. The lens may be formed of glass or plastic and may be manufactured by a suitable method (e.g., known in the art with regard to typical pancake lenses).

Next, the present disclosure will be described in more detail with reference to some examples. However, it should be noted that these examples are provided for illustration only and are not to be construed in any way as limiting the present disclosure.

### Example 1

### Preparation of Optical Laminate

A negative dispersion retardation layer (liquid crystal retardation layer, thickness: 2 μm, short-wavelength dispersion: 0.86, long-wavelength dispersion: 1.02) was prepared.

A reflective polarizer (two layers of a film with alternating high and low refractive index layers, thickness: 54 μm, IQP-E, 3M Company) and a pancake lens with a half mirror (HARP, 3M Company) were prepared.

A first polarizer (light transmittance: 44%, cross transmittance: 0.07%, thickness: 12 μm) was prepared by dyeing a polyvinyl alcohol film (pre-stretching thickness: 60 μm, Kuraray Co., Ltd., Japan) in an aqueous solution of iodine at 55° C., followed by uniaxially stretching the dyed film to six times an initial length thereof in the MD thereof.

A triacetylcellulose film (Normal TAC film, thickness: 29 μm) with a hard coating layer formed thereon was used as a first protective layer.

A triacetylcellulose film (Zero TAC film, thickness: 20 μm) was used as a second protective layer.

An adhesive was applied to one or both surfaces of the prepared polarizer, followed by attaching the first protective layer and the second protective layer to the polarizer, and then the adhesive was cured, thereby preparing a polarizing plate. Here, each adhesive layer had a thickness of 50 nm, which had a negligible effect on the thickness of the polarizing plate.

The pancake lens, the negative dispersion retardation layer, the reflective polarizer, and the polarizing plate were sequentially bonded to one another, thereby obtaining an optical laminate. An acrylic pressure sensitive adhesive layer was used in the bonding process.

### Preparation of First Polarizing Plate

A first polarizer (light transmittance: 44%, cross transmittance: 0.07%, thickness: 10 μm) was prepared by dyeing a polyvinyl alcohol film (pre-stretching thickness: 60 μm, Kuraray Co., Ltd., Japan) in an aqueous solution of iodine at 55° C., followed by uniaxially stretching the dyed film to six times an initial length thereof in the MD thereof.

After a triacetylcellulose film was attached to one surface of the first polarizer, a composition including an acrylic resin was coated onto one surface of the triacetylcellulose film, followed by curing, thereby preparing a laminate in which the first polarizer, the triacetylcellulose film, and a resin layer were sequentially formed.

A first retardation layer and a second retardation layer were attached to opposite surfaces of the prepared laminate, thereby obtaining a first polarizing plate having a stacked structure of first retardation layer (liquid crystal layer)-first polarizer-triacetylcellulose film-resin layer-second retardation layer (liquid crystal layer). Each of the first retardation layer and the second retardation layer had negative dispersion properties and had a short-wavelength dispersion of 0.86 and a long-wavelength dispersion of 1.02.

### Preparation of Module for Stereoscopic Image Display Apparatus

A module for stereoscopic image display apparatuses was prepared by arranging the first polarizing plate, a display unit having an organic light emitting diode (OLED), and the pancake lens assembly as shown in FIG. 8. Here, the slow axis of the second retardation film of the first polarizing plate was at an angle of 90° to the slow axis of the retardation film of the pancake lens assembly.

In the first polarizing plate, the light absorption axis of the polarizer was at an angle of 45° to the slow axis of the first retardation film, and the slow axis of the first retardation film was at an angle of 90° to the slow axis of the second retardation film.

### Examples 2 and 3

Modules for stereoscopic image display apparatuses were prepared in the same manner as in Example 1 except that the thicknesses of the polarizer, the first protective layer, and the second protective layer were changed as listed in Table 1.

### Example 4

### Preparation of Optical Laminate

A negative dispersion retardation layer (liquid crystal retardation layer, thickness: 2 μm, short-wavelength dispersion: 0.86, long-wavelength dispersion: 1.02) was prepared.

A reflective polarizer (two layers of a film with alternating high and low refractive index layers, thickness: 54 μm, IQP-E, 3M Company) and a pancake lens with a half mirror (HARP, 3M Company) were prepared.

A first polarizer (light transmittance: 44%, cross transmittance: 0.2%, thickness: 12 μm) was prepared by dyeing a polyvinyl alcohol film (pre-stretching thickness: 60 μm, Kuraray Co., Ltd., Japan) in an aqueous solution of iodine at 55° C., followed by uniaxially stretching the dyed film to six times an initial length thereof in the MD thereof.

A triacetylcellulose film (Normal TAC film, thickness: 29 μm) with a hard coating layer formed thereon was used as a first protective layer.

An adhesive was applied to one surface of the prepared polarizer, followed by attaching the first protective layer to the polarizer, and then the adhesive was cured, thereby preparing a polarizing plate. Here, each adhesive layer had a thickness of 50 nm, which had a negligible effect on the thickness of the polarizing plate.

The pancake lens, the negative dispersion retardation layer, the reflective polarizer, and the polarizing plate were sequentially bonded to one another, thereby obtaining an optical laminate. An acrylic pressure sensitive adhesive layer was used in the bonding process.

Thereafter, a module for stereoscopic image display apparatuses was prepared in the same manner as in Example 1

### Examples 5 and 6

Modules for stereoscopic image display apparatuses were prepared in the same manner as in Example 4 except that the thicknesses of the polarizer and the first protective layer, were changed as listed in Table 1.

### Comparative Examples 1 and 2

Modules for stereoscopic image display apparatuses were prepared in the same manner as in Example 1 except that the thicknesses of the polarizer, the first protective layer, and the second protective layer were changed as listed in Table 1.

### Comparative Example 3

A module for stereoscopic image display apparatuses was prepared in the same manner as in Example 4 except that the thicknesses of the polarizer, the first protective layer, and the second protective layer were changed as listed in Table 1.

Each of the modules for stereoscopic image display apparatuses prepared in Examples and Comparative Examples was evaluated as to the following properties. Results are shown in Table 1.
Resolution (modulation transfer function (MTF)) (unit: %): Resolution was evaluated by measuring a contrast ratio, that is, a difference in brightness between light and dark areas on a screen, using an imaging photometer (ProMetric, Radiant Imaging Co.). A higher MTF value indicates better resolution.

MTF={(Maximum contrast ratio-Minimum contrast ratio)/(Maximum contrast ratio+Minimum contrast ratio)}×100
Light leakage: Diagonal light leakage was observed with the naked eye in a darkroom. When no light leakage was observed with the naked eye, a corresponding module was rated as “undetectable” and, when light leakage was observed with the naked eye, a corresponding module was rated as “weak”, “medium”, or “strong” based on the observed intensity of light leakage.

TABLE 1

| | Thickness (μm) | | | | | |
|---|---|---|---|---|---|---|
| | First protective | | Second protective | Polarizing | | Light |
| | layer | Polarizer | layer | plate | Resolution | leakage |
| Example 1 | 29 | 12 | 20 | 61 | 86 | Undetectable |
| Example 2 | 29 | 12 | 29 | 70 | 83 | Undetectable |
| Example 3 | 24 | 12 | 20 | 56 | 89 | Undetectable |
| Example 4 | 29 | 12 | — | 41 | 93 | Undetectable |
| Example 5 | 24 | 22 | — | 46 | 93 | Undetectable |
| Example 6 | 29 | 22 | — | 51 | 91 | Undetectable |
| Comparative | 45 | 12 | 20 | 77 | 71 | Medium |
| Example 1 | | | | | | |
| Comparative | 29 | 12 | 40 | 81 | 68 | Medium |
| Example 2 | | | | | | |
| Comparative | 49 | 29 | — | 78 | 75 | Weak |
| Example 3 | | | | | | |

As can be seen from Table 1, the optical laminates of Examples could minimize refraction and/or scattering due to abnormal light transmitted from the reflective polarizer while minimizing phase delay of the light. This indicates that the optical laminate according to the present disclosure can improve the contrast ratio and resolution and can eliminate light leakage at an edge of a screen within a viewer's field of view.

As used herein, the terms “use,” “using,” and “used” may be considered synonymous with the terms “utilize,” “utilizing,” and “utilized,” respectively. As used herein, the term “one surface” and the “other surface”, unless stated otherwise, refer to two opposing surfaces of a member.

The use of “may” when describing embodiments of the inventive concept refers to “one or more embodiments of the inventive concept.”

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

It should be understood that various modifications, changes, alterations, and equivalent embodiments can be made by those skilled in the art without departing from the spirit and scope of the disclosure. Accordingly, it is to be understood that present disclosure is not limited to the disclosed embodiments, but, on the contrary, is intended to cover various modifications and equivalent arrangements included within the spirit and scope of the appended claims, and equivalents thereof.

1 what is claimed is:

1. An optical laminate for stereoscopic image display apparatuses, comprising:
a negative dispersion retardation layer; and
a reflective polarizer and a polarizing plate, sequentially formed on at least one surface of the negative dispersion retardation layer,
wherein the polarizing plate comprises a polarizer and satisfies condition (i) or (ii):
(i) a first protective layer is formed on a first surface of the polarizer and a second protective layer is formed on a second surface of the polarizer, the second surface facing away from the first surface, and each of the first and second protective layers is 30 μm or less in thickness; and
(ii) a single protective layer is formed on the first surface or the second surface of the polarizer, and the polarizing plate is 70 μm or less in thickness.

2. The optical laminate as claimed in claim 1, wherein the polarizing plate satisfies condition (i) and comprises the polarizer, the second protective layer formed between the polarizer and the reflective polarizer, and the first protective layer formed on the first surface of the polarizer, the first surface facing away from the reflective polarizer.

3. The optical laminate as claimed in claim 2, wherein the polarizing plate is 70 μm or less in thickness.

4. The optical laminate as claimed in claim 2, wherein the second protective layer has an in-plane retardation of 5 nm or less at a wavelength of 550 nm.

5. The optical laminate as claimed in claim 2, wherein the first protective layer has an in-plane retardation of 10 nm or less at a wavelength of 550 nm.

6. The optical laminate as claimed in claim 2, wherein the second protective layer has a lower in-plane retardation at a wavelength of 550 nm than the first protective layer.

7. The optical laminate as claimed in claim 2, wherein at least one of the first protective layer or the second protective layer comprises a functional coating layer.

8. The optical laminate as claimed in claim 1, wherein the polarizing plate satisfies condition (ii).

9. The optical laminate as claimed in claim 8, wherein the single protective layer is 30 μm or less in thickness.

10. The optical laminate as claimed in claim 8, wherein the single protective layer has an in-plane retardation of 10 nm or less at a wavelength of 550 nm.

11. The optical laminate as claimed in claim 1, wherein the reflective polarizer has a light transmittance of 1% or less in a light reflection direction thereof.

12. The optical laminate as claimed in claim 1, wherein the polarizer has a cross transmittance of 0.3% or less.

13. The optical laminate as claimed in claim 1, further comprising: a pancake lens formed on a surface of the negative dispersion retardation layer.

14. The optical laminate as claimed in claim 1, wherein a light absorption axis of the polarizer is tilted at an angle of 44° to 46° or at an angle of 134° to 136° with respect to a slow axis of the negative dispersion retardation layer.

15. The optical laminate as claimed in claim 1, further comprising: a lens on at least one surface of the negative dispersion retardation layer.

16. A stereoscopic image display apparatus comprising the optical laminate as claimed in claim 1.

17. The stereoscopic image display apparatus as claimed in claim 16, comprising:
a display unit;
a first polarizing plate; and
a pancake lens assembly,
wherein the pancake lens assembly comprises the optical laminate.

18. The stereoscopic image display apparatus as claimed in claim 17, further comprising: a second polarizing plate between the first polarizing plate and the pancake lens assembly.
